(19) United States
(12) Patent Application Publication
(10) Pub. No.: US 2016/0307490 A1
(43) Pub. Date: Oct. 20, 2016

(54) ORGANIC LIGHT-EMITTING DIODE DISPLAY AND METHOD OF DRIVING THE SAME

(71) Applicant: Samsung Display Co., Ltd., Yongin-si (KR)

(72) Inventors: Jae-Hoon Lee, Seoul (KR); Do-Hyung Ryu, Yongin-si (KR); Seung-Ho Park, Suwon-si (KR); Jae-Woo Song, Anyang-si (KR); Hae-Goo Jung, Seongnam-si (KR)

(21) Appl. No.: 15/019,817

(22) Filed: Feb. 9, 2016

(30) Foreign Application Priority Data
Apr. 15, 2015 (KR) 10-2015-0053249

(51) Int. Cl. G09G 3/20; G09G 3/32

(52) U.S. Cl. CPC G09G 3/2007; G09G 3/3208; G09G 2330/023; G09G 2320/0271; G09G 2330/12

(57) ABSTRACT

An organic light-emitting diode display and a method of driving the same are disclosed. In one aspect, the display includes a display panel and an image data converter configured to determine a grayscale gain based on a grayscale distribution of input image data and convert the input image data into output image data based on the grayscale gain. A display panel driver is configured to drive the display panel to display an image corresponding to the output image data, and a target current determiner is configured to determine a magnitude of a target current based on the input image data. The display also includes a power supply configured to provide a power source to the display panel and adjust the voltage level of the power source to correspond to the target current via a power line.

### CROSS REFERENCE TO RELATED APPLICATION

This application claims priority under 35 U.S.C. §119 to Korean patent Application No. 10-2015-0053249 filed on Apr. 15, 2015, the disclosure of which is hereby incorporated by reference herein in its entirety.

### BACKGROUND

1. Field

The described technology generally relates to organic light-emitting diode displays and methods of driving the same.

2. Description of the Related Technology

Generally, an organic light-emitting diode (OLED) includes an organic layer between an anode electrode and a cathode electrode. Positive holes from the anode are combined with electrons from the cathode in the organic layer between the anode and the cathode to emit light.

An OLED display can be driven by a digital driving technique. The digital driving technique displays one frame by displaying a plurality of sub-frames. That is, in the digital driving technique, one frame is divided into a plurality of sub-frames, each emission time of the sub-frames is differently set (e.g., by a factor of 2), and a specific grayscale level is displayed using a sum of emission times of the sub-frames. The digital driving technique has a simple structure compared to other driving techniques. Also, the digital driving technique has the ability to express low grayscale well.

### SUMMARY OF CERTAIN INVENTIVE ASPECTS

One inventive aspect relates to an OLED display and a method of driving the same that can reduce power consumption.

Another aspect is an OLED display that can include a display panel including a plurality of pixels, an image data converter configured to determine a grayscale gain based on a grayscale distribution of input image data, and to convert the input image data into output image data using the grayscale gain, a display panel driver configured to drive the display panel to display an image corresponding to the output image data, a target current determiner configured to determine a magnitude of a target current based on the input image data, and a power supply configured to adjust a voltage level of a power source to provide the power source corresponding to the target current to the display panel through a power line.

In example embodiments, the image data converter includes a grayscale distribution analyzer configured to derive the grayscale distribution from the input image data, a grayscale gain determiner configured to determine the grayscale gain based on the grayscale distribution, and an output image data generator configured to generate the output image data by multiplying the grayscale gain and the input image data.

In example embodiments, the grayscale gain determiner calculates an excess grayscale proportion of grayscale values exceeding a reference grayscale level from the grayscale distribution and determines the grayscale gain corresponding to the excess grayscale proportion.

In example embodiments, the grayscale gain determiner increases the grayscale gain as the excess grayscale proportion decreases.

In example embodiments, the grayscale gain determiner compares the excess grayscale proportion to at least one of threshold values to determine the grayscale gain.

In example embodiments, the grayscale gain determiner determines a reference grayscale level such that an excess grayscale proportion of grayscale values exceeding the reference grayscale level is larger than a threshold value and determines the grayscale gain such that the reference grayscale level is converted into a maximum output grayscale level.

In example embodiments, the grayscale gain determiner derives a maximum input grayscale value from the grayscale distribution and determines the grayscale gain based on the maximum input grayscale value.

In example embodiments, the target current determiner calculates the magnitude of the target current according to [Equation 1] below:

Itarget=εᵣGᵣ+ε_{g}G_{g}+ε_{b}G_{b}, [EQUATION 1]

wherein ITARGET is the magnitude of the target current, εᵣ is a weight value for a red color pixel, Gᵣ is a red color grayscale value in the input image data, ε_{g} is a weight value for a green color pixel, G_{g} is a green color grayscale value in the input image data, ε_{b} is a weight value for a blue color pixel, and G_{b} is a blue color grayscale value in the input image data.

In example embodiments, the power supply includes a power generator configured to generate the power source, a current measurer configured to measure a magnitude of a sensing current flowing through the power line, and a power adjuster configured to compare the magnitude of the sensing current to the magnitude of the target current, and to adjust the voltage level the power source such that the magnitude of the sensing current reaches to the magnitude of the target current.

In example embodiments, the power generator generates a first power source and a second power source as the power source. A voltage level the first power source can be higher than a voltage level the second power source.

In example embodiments, the power adjuster adjusts the voltage level of the first power source such that the magnitude of the sensing current reaches to the magnitude of the target current.

In example embodiments, the power adjuster decreases the voltage level of the first power source as the grayscale gain increases.

In example embodiments, the image data converter periodically updates the grayscale gain.

In example embodiments, the image data converter updates the grayscale gain in every frame.

In example embodiments, the display panel driver drives the display panel by a digital driving technique.

Another aspect is a method of driving an OLED display. The method can include deriving a grayscale distribution from input image data, determining a grayscale gain based on the grayscale distribution, generating output image data by multiplying the grayscale gain and the input image data, determining a magnitude of a target current based on the input image data, adjusting a voltage level of a power source to provide the power source corresponding to the target current to a display panel, and displaying an image corresponding to the output image data.

In example embodiments, determining the grayscale gain includes calculating an excess grayscale proportion of grayscale values exceeding a reference grayscale level from the grayscale distribution, and determining the grayscale gain such that the grayscale gain increases as the excess grayscale proportion decreases.

In example embodiments, determining the grayscale gain includes determining a reference grayscale level such that an excess grayscale proportion of grayscale values exceeding the reference grayscale level is larger than a threshold value, and determining the grayscale gain such that the reference grayscale level is converted into a maximum output grayscale level.

In example embodiments, adjusting the voltage level of the power source includes measuring a magnitude of a sensing current flowing through a power line, comparing the magnitude of the sensing current to the magnitude of the target current, and adjusting the voltage level the power source such that the magnitude of the sensing current reaches to the magnitude of the target current.

In example embodiments, the voltage level of the power source decreases as the grayscale gain increases.

Another aspect is an organic light-emitting diode (OLED) display, comprising: a display panel including a plurality of pixels; an image data converter configured to determine a grayscale gain based on a grayscale distribution of input image data and convert the input image data into output image data based on the grayscale gain; a display panel driver configured to drive the display panel to display an image corresponding to the output image data; a target current determiner configured to determine a magnitude of a target current based on the input image data; and a power supply configured to provide a power source to the display panel and adjust the voltage level of the power source to correspond to the target current via a power line.

In the above display, the image data converter includes: a grayscale distribution analyzer configured to derive the grayscale distribution from the input image data; a grayscale gain determiner configured to determine the grayscale gain based on the grayscale distribution; and an output image data generator configured to multiply the grayscale gain with the input image data so as to generate the output image data.

In the above display, the grayscale gain determiner is further configured to calculate an excess grayscale proportion of a plurality of grayscale values of the grayscale distribution that exceed a reference grayscale level and determine the grayscale gain corresponding to the excess grayscale proportion.

In the above display, the grayscale gain determiner is further configured to increase the grayscale gain when the excess grayscale proportion decreases.

In the above display, the grayscale gain determiner is further configured to compare the excess grayscale proportion to at least one of a plurality of threshold values and determine the grayscale gain based on the comparison.

In the above display, the grayscale gain determiner is further configured to determine the reference grayscale level such that the excess grayscale proportion is greater than a predetermined threshold value and determine the grayscale gain such that the reference grayscale level corresponds to a maximum output grayscale level.

In the above display, the grayscale gain determiner is further configured to derive a maximum input grayscale value from the grayscale distribution and determine the grayscale gain based on the maximum input grayscale value.

In the above display, the target current determiner is further configured to calculate the magnitude of the target current according to [Equation 1] below:

Itarget=εᵣGᵣ+ε_{g}G_{g}+ε_{b}G_{b}, [Equation 1]

wherein Itarget is the magnitude of the target current, εᵣ is a weight value for a red color pixel, Gᵣ is a red color grayscale value in the input image data, ε_{g} is a weight value for a green color pixel, G_{g} is a green color grayscale value in the input image data, ε_{b} is a weight value for a blue color pixel, and G_{b} is a blue color grayscale value in the input image data.

In the above display, the power supply includes: a power generator configured to generate the power source; a current measurer configured to measure a magnitude of a sensing current flowing through the power line; and a power adjuster configured to compare the magnitude of the sensing current to the magnitude of the target current and adjust the voltage level of the power source such that the magnitude of the sensing current is substantially equal to the magnitude of the target current.

In the above display, the power source includes a first power source and a second power source, wherein a voltage level of the first power source is greater than a voltage level of the second power source.

In the above display, the power adjuster is further configured to adjust the voltage level of the first power source such that the magnitude of the sensing current is substantially equal to the magnitude of the target current.

In the above display, the power adjuster is further configured to decrease the voltage level of the first power source when the grayscale gain increases.

In the above display, the image data converter is further configured to periodically update the grayscale gain.

In the above display, the image data converter is further configured to update the grayscale gain every frame.

In the above display, the display panel driver is further configured to drive the display panel via a digital driving technique.

Another aspect is a method of driving an organic light-emitting diode (OLED) display, the method comprising: deriving a grayscale distribution from input image data; determining a grayscale gain based on the grayscale distribution; multiplying the grayscale gain with the input image data so as to generate output image data; determining a magnitude of a target current based on the input image data; adjusting a voltage level of a power source to provide the power source corresponding to the target current to a display panel; and displaying an image corresponding to the output image data.

In the above method, determining the grayscale gain includes: calculating an excess grayscale proportion of a plurality of grayscale values of the grayscale distribution that exceed a reference grayscale level; and determining the grayscale gain such that the grayscale gain increases when the excess grayscale proportion decreases.

In the above method, determining the grayscale gain includes: determining a reference grayscale level such that an excess grayscale proportion of a plurality of grayscale values that exceed the reference grayscale level is greater than a predetermined threshold value; and determining the grayscale gain such that the reference grayscale level corresponds to a maximum output grayscale level.

In the above method, adjusting the voltage level of the power source includes: measuring a magnitude of a sensing current flowing through a power line; comparing the magnitude of the sensing current to the magnitude of the target current; and adjusting the voltage level of the power source based on the comparison such that the magnitude of the sensing current is substantially equal to the magnitude of the target current.

In the above method, the voltage level of the power source decreases when the grayscale gain increases.

According to at least one of the disclosed embodiments, an OLED display can determine a grayscale gain based on a grayscale distribution of input image data and converts the input image data into output image data using the grayscale gain. In addition, the OLED display can determine a magnitude of a target current based on the input image data and adjusts a voltage level of a power source to provide the power source corresponding to the target current to the display panel. Because the OLED display can maintain the total amount of current flowing through the display panel, the OLED display can decrease the voltage level of the power source without luminance degradation, thereby reducing the power consumption.

The method of driving the OLED display can reduce the power consumption without luminance degradation.

### BRIEF DESCRIPTION OF THE DRAWINGS

FIG. 1 is a block diagram illustrating an OLED display according to example embodiments.

FIG. 2 is a block diagram illustrating an example of an image data converter included in the OLED display of FIG. 1.

FIGS. 3A and 3B are graphs for describing one example of determining a grayscale gain based on a grayscale distribution of input image data.

FIGS. 4A and 4B are graphs for describing another example of determining a grayscale gain based on a grayscale distribution of input image data.

FIGS. 5A and 5B are graphs for describing still another example of determining a grayscale gain based on a grayscale distribution of input image data.

FIGS. 6A and 6B are graphs for describing still another example of determining a grayscale gain based on a grayscale distribution of input image data.

FIG. 7 is a block diagram illustrating an example of a power supply included in the OLED display of FIG. 1.

FIG. 8 is a graph for describing an example of adjusting a voltage level of a power source to provide the power source corresponding to a target current.

FIGS. 9 and 10 are diagrams illustrating examples where a display panel driver drives a display panel in the OLED display of FIG. 1.

FIG. 11 is a graph for describing an effect of the OLED display of FIG. 1.

FIG. 12 is a flowchart illustrating a method of driving an OLED display according to one example embodiment.

### DETAILED DESCRIPTION OF CERTAIN INVENTIVE EMBODIMENTS

Exemplary embodiments will be described more fully hereinafter with reference to the accompanying drawings, in which various embodiments are shown. In this disclosure, the term “substantially” includes the meanings of completely, almost completely or to any significant degree under some applications and in accordance with those skilled in the art. Moreover, “formed on” can also mean “formed over.” The term “connected” can include an electrical connection.

Referring to FIG. 1, the OLED display 1000 includes a display panel 100, an image data converter 200, a display panel driver 300, a target current determiner 400, and a power supply 500. Depending on embodiments, certain elements may be removed from or additional elements may be added to the OLED display 1000 illustrated in FIG. 1. Furthermore, two or more elements may be combined into a single element, or a single element may be realized as multiple elements. This also applies to the remaining disclosed embodiments.

The display panel 100 can include a plurality of pixels to display an image. For example, the display panel 100 is connected to the scan driver of the display panel driver 300 via scan lines. The display panel 100 can be connected to the data driver of display panel driver 300 via data lines. The pixels can be arranged at locations corresponding to crossing points of the scan lines and the data lines.

The image data converter 200 can determine a grayscale gain based on a grayscale distribution of input image data IDATA. Here, the grayscale gain indicates a ratio of a grayscale level of the input image data IDATA to a grayscale level of the converted output image data ODATA. For example, the grayscale gain is a slope in a graph of a relationship between the input image data IDATA and the output image data ODATA (i.e., the grayscale level of the output image data/the grayscale level of the input image data). The image data converter 200 can determine the grayscale gain to be greater than or substantially equal to 1 according to the grayscale distribution. For example, when a proportion of low grayscale is relatively large in the grayscale distribution of the input image data IDATA, the image data converter 200 determines the grayscale gain as a relatively large value. On the other hand, when a proportion of high grayscale is relatively large in the grayscale distribution of the input image data IDATA, the image data converter 200 can determine the grayscale gain to be a relatively small value. The image data converter 200 can convert the input image data IDATA into output image ODATA data using the grayscale gain. For example, the image data converter 200 can generate the output image data ODATA by multiplying the grayscale gain and the input image data IDATA.

The image data converter 200 can substantially periodically update the grayscale gain. In some embodiments, the image data converter 200 updates the grayscale gain in every frame. Thus, the grayscale distribution of the input image data IDATA can be derived in every frame, and the grayscale gain can be determined corresponding to the derived grayscale distribution. In some embodiments, the image data converter 200 updates the grayscale gain substantially every second. For example, if the input image data IDATA corresponds to a still image or a static image where data is not largely changed, the image data converter 200 updates the grayscale gain periodically, e.g., every second. The image data converter 200 can determine the grayscale gain corresponding to the derived grayscale distribution substantially every second, thereby reducing a load of the image data converter 200.

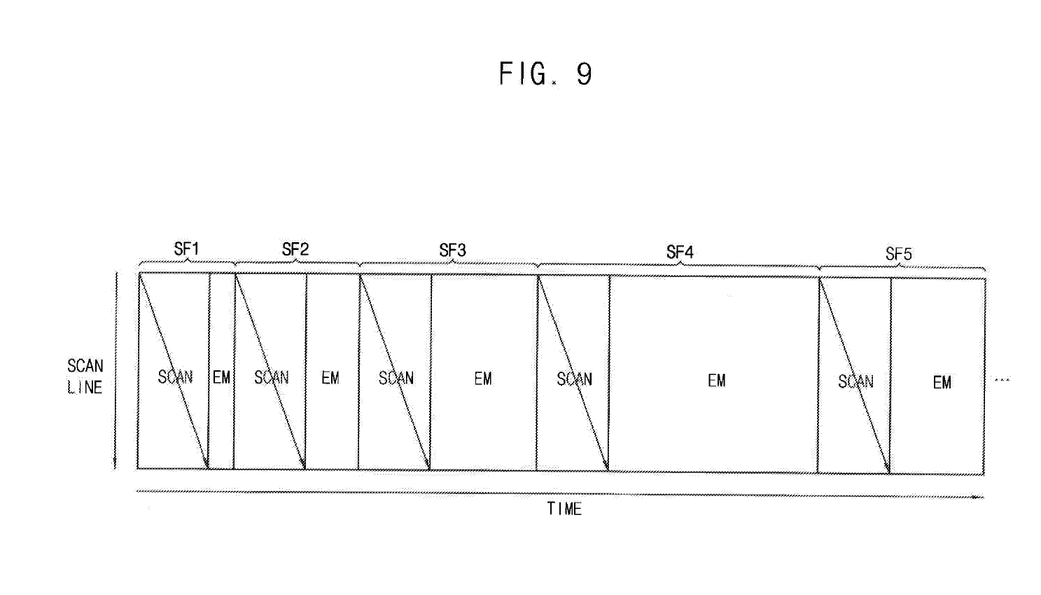

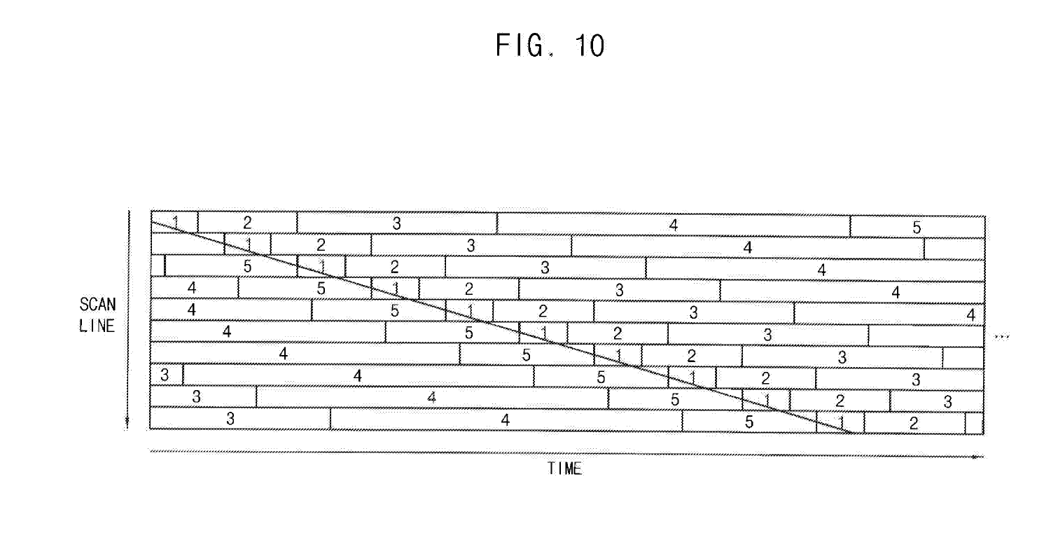

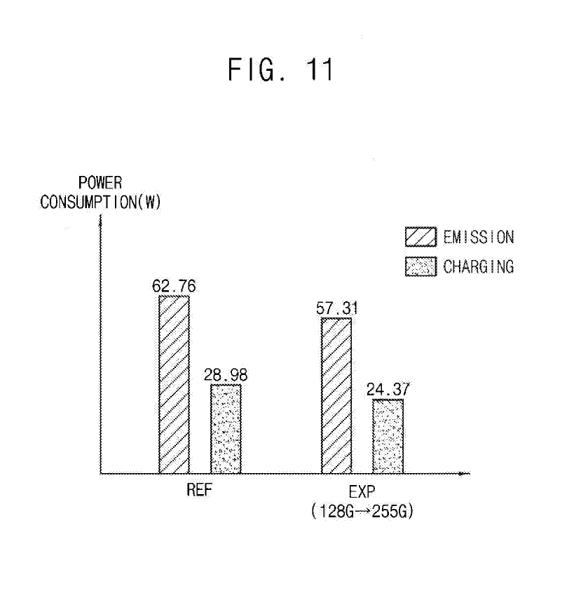

The display panel driver 300 can drive the display panel 100 to display an image corresponding to the output image data ODATA. For example, the display panel driver 300 includes a data driver, a scan driver, and a timing controller. The display panel driver 300 can provide a driving signal DS for displaying the image to the display panel 100. In some embodiments, the display panel driver 300 drives the display panel 100 by a digital driving technique. The digital driving technique displays a frame by displaying a plurality of sub-frames. Hereinafter, a method of driving the display panel 100 by the display panel driver 300 will be described in more detail with reference to FIGS. 9 and 10.

The target current determiner 400 can determine a magnitude of a target current ITARGET based on the input image data IDATA. Thus, the target current determiner 400 can determine the magnitude of the target current ITARGET to maintain a total amount of current flowing through the display panel 100. In some embodiments, the target current determiner 400 calculates the magnitude of the target current ITARGET according to [Equation 1] below:

Itarget=εᵣGᵣ+ε_{g}G_{g}+ε_{b}G_{b}, [EQUATION 1]

where, Itarget is the magnitude of the target current, εᵣ is a weight value for a red color pixel, Gᵣ is a red color grayscale value in the input image data, ε_{g} is a weight value for a green color pixel, G_{g} is a green color grayscale value in the input image data, ε_{b} is a weight value for a blue color pixel, and G_{b} is a blue color grayscale value in the input image data.

The power supply 500 can adjust a voltage level of a power source to provide the power source corresponding to the target current ITARGET to the display panel 100 through a power line. In some embodiments, the power generator generates a first power source and a second power source as the power source, and a voltage level of the first power source can be greater than a voltage level of the second power source. For example, the first power source corresponds to a high power voltage ELVDD, and the second power source corresponds to a low power voltage ELVSS. The power supply 500 can provide the power sources corresponding to the target current ITARGET to the display panel 100 through the power line by adjusting the voltage level of the power source. Thus, the power supply 500 can measure a magnitude of a sensing current flowing through the power line and adjust the voltage level the power source (e.g., the first power source corresponding to the high power voltage ELVDD) such that the magnitude of the sensing current reaches the magnitude of the target current ITARGET. Therefore, the power supply 500 can maintain the total amount of current flowing through the display panel 100, thereby preventing the luminance degradation or luminance changing.

Therefore, the OLED display 1000 can determine the grayscale gain based on the grayscale distribution of input image data IDATA and convert the input image data IDATA into output image data ODATA using the grayscale gain. In addition, the OLED display 1000 can determine the magnitude of the target current ITARGET based on the input image data IDATA and adjust the voltage level of the power source to provide the power source corresponding to the target current ITARGET to the display panel 100. As a result, the total amount of current flowing through the display panel 100 can be maintained. Therefore, the OLED display 1000 can determine the grayscale gain to convert the input image data IDATA and adjust the voltage level of the power source to maintain the total amount of the current, thereby reducing the power consumption without the luminance degradation.

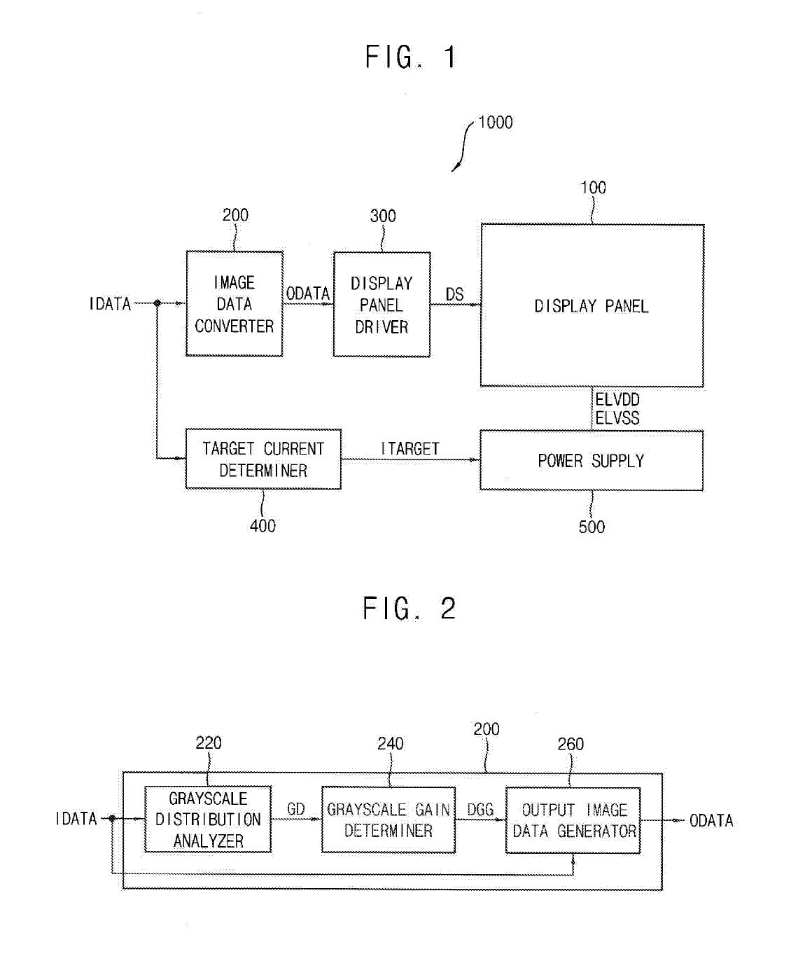

FIG. 2 is a block diagram illustrating an example of an image data converter included in the OLED display of FIG. 1.

Referring to FIG. 2, the image data converter 200 includes a grayscale distribution analyzer 220, a grayscale gain determiner 240, and an output image data generator 260.

The grayscale distribution analyzer 220 can derive the grayscale distribution GD from the input image data IDATA. For example, the grayscale distribution analyzer 220 counts the number of grayscale values for each grayscale level. The grayscale distribution analyzer 220 can count the total number of the grayscale values as the grayscale level increases. The grayscale distribution analyzer 220 can count the number of the grayscale values exceeding the reference grayscale level. Also, the grayscale distribution analyzer 220 can derive the maximum input grayscale value among the grayscale values in the input image data IDATA.

The grayscale gain determiner 240 can determine the grayscale gain DGG based on the grayscale distribution GD. When a proportion of low grayscale is relatively large in the grayscale distribution GD of the input image data IDATA, the grayscale gain determiner 240 can determine the grayscale gain DGG as a relatively large value. On the other hand, when a proportion of high grayscale is relatively large in the grayscale distribution GD of the input image data IDATA, the grayscale gain determiner 240 can determine the grayscale gain DGG as a relatively small value.

In some embodiments, the grayscale gain determiner 240 calculates an excess grayscale proportion of grayscale values exceeding a reference grayscale level from the grayscale distribution GD and determine the grayscale gain DGG corresponding to the excess grayscale proportion. Thus, the grayscale gain determiner 240 can calculate the excess grayscale proportion by dividing the number of pixels of which grayscale values are greater than the reference grayscale level by the number of all pixels. The grayscale gain determiner 240 can determine the grayscale gain DGG corresponding to the excess grayscale proportion.

In some embodiments, the grayscale gain determiner 240 determines a reference grayscale level such that an excess grayscale proportion of grayscale values exceeding the reference grayscale level is greater than a predetermined threshold value. The grayscale gain determiner 240 can determine the grayscale gain DGG such that the reference grayscale level is converted into a maximum output grayscale level. Thus, the grayscale gain determiner 240 can determine the reference grayscale level such that the excess grayscale proportion is greater than the threshold value based on the grayscale distribution GD. Thereafter, the grayscale gain determiner 240 can determine the grayscale gain DGG corresponding to the determined reference grayscale level.

In some example embodiments, the grayscale gain determiner 240 derives a maximum input grayscale value from the grayscale distribution GD and determines the grayscale gain DGG based on the maximum input grayscale value.

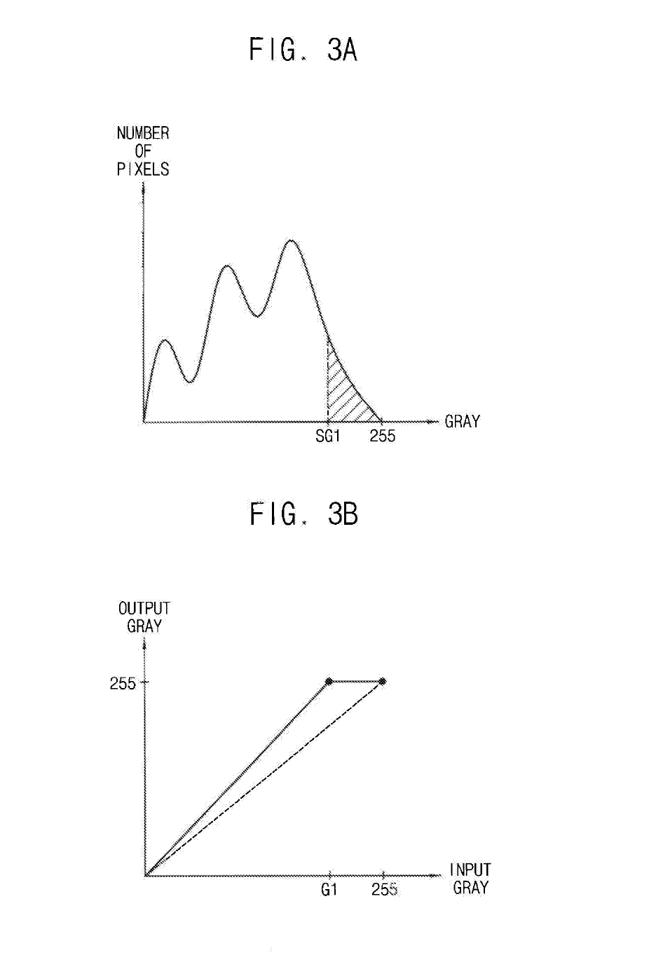

Hereinafter, methods of determining the grayscale gain DGG based on the grayscale distribution GD will be described in more detail with reference to the FIGS. 3 through 6B.

The output image data generator 260 can convert the input image data IDATA into the output image data ODATA using the grayscale gain DGG. In some embodiments, the output image data generator 260 generates the output image data ODATA by multiplying the grayscale gain DGG and the input image data IDATA. For example, the output image data generator 260 stores a relationship between the input image data IDATA and the output image data ODATA in the look-up table (LUT). The output image data generator 260 can convert the input image data IDATA into the output image data ODATA using the LUT.

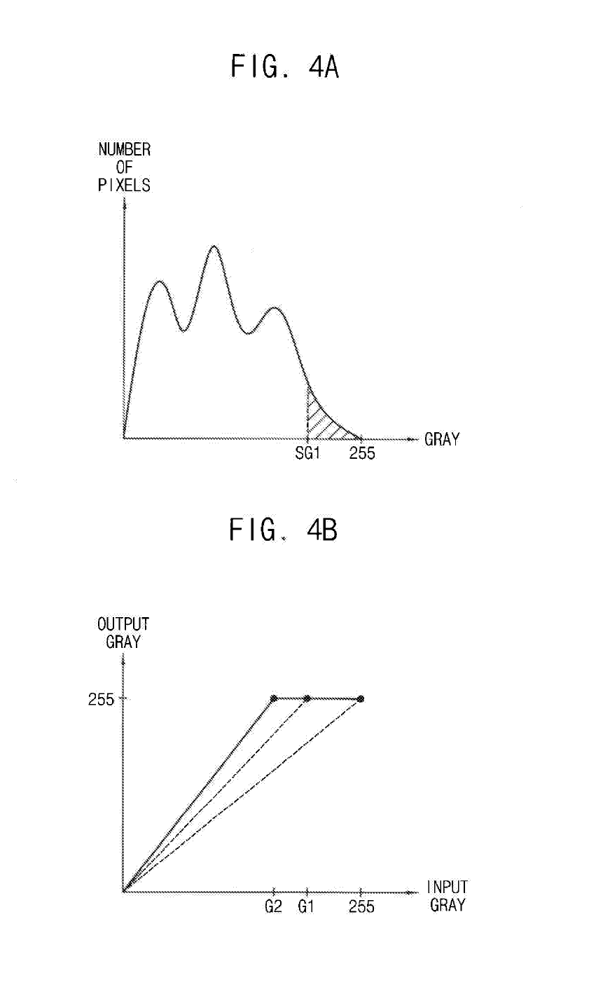

FIGS. 3A and 3B are graphs for describing one example of determining a grayscale gain based on a grayscale distribution of input image data. FIGS. 4A and 4B are graphs for describing another example of determining a grayscale gain based on a grayscale distribution of input image data.

Referring to FIGS. 3A through 4B, an excess grayscale proportion of grayscale values exceeding a reference grayscale level is calculated from the grayscale distribution and the grayscale gain corresponding to the excess grayscale proportion can be determined. In some embodiments, the grayscale gain is increased as the excess grayscale proportion decreases. In some embodiments, the grayscale gain is determined by comparing the excess grayscale proportion to at least one of threshold values.

As shown in FIG. 3A, the number of grayscale values for each grayscale level is counted. A grayscale distribution indicating a relationship between the grayscale level and the number of pixels can be derived. Also, a proportion of grayscale values exceeding a first reference grayscale level SG1 (i.e., the excess grayscale proportion) can be calculated. For example, the first excess grayscale proportion of grayscale values exceeding the first reference grayscale level SG1 is about 4.5%.

As shown in FIG. 3B, the grayscale gain corresponding to the first excess grayscale proportion is generated, and a relationship between the input image data and the output image data is determined. For example, when the first threshold value is about 5% and the second threshold value is about 3%, because the first excess grayscale proportion of about 4.5% is less than the first threshold and greater than the second threshold, the first excess grayscale proportion can correspond to a first section between the first threshold and the second threshold. The grayscale gain can be set to about 1.1 corresponding to the first section. Also, a first input grayscale level G1 can be set to about 232. Here, the first input grayscale level G1 indicates a minimum grayscale level of being converted into the maximum output grayscale level by the grayscale gain. The maximum output grayscale level indicates the maximum value of the output image data (e.g., about 255). Therefore, the relationship between the input image data and the output image data can be determined, and the input image data can be converted into the output image data.

As shown in FIG. 4A, the number of grayscale values for each grayscale level is counted from the input image data. The grayscale distribution indicating a relationship between the grayscale level and the number of the pixels can be derived. Also, the excess grayscale proportion can be calculated using the grayscale distribution. For example, a second excess grayscale proportion of grayscale values exceeding the first reference grayscale level SG1 can be about 2.5%.

As shown in FIG. 4B, the grayscale gain corresponding to the second excess grayscale proportion is generated, and a relationship between the input image data and the output image data is determined. For example, when the second threshold value is about 3% and the third threshold value is about 2%, because the second excess grayscale proportion of about 2.5% is less than the second threshold and greater than the third threshold, the second excess grayscale proportion can correspond to a second section between the second threshold and the third threshold. The grayscale gain can be set to about 1.2 corresponding to the second section. Also, a second input grayscale level G2 can be set to about 213. Here, the second input grayscale level G2 indicates a minimum grayscale level of being converted into the maximum output grayscale level by the grayscale gain. The maximum output grayscale level indicates the maximum value of the output image data (e.g., 255). Therefore, the relationship between the input image data and the output image data can be determined, and the input image data can be converted into the output image data.

Although the example embodiments of FIGS. 3A through 4B describe the excess grayscale proportion being compared to the threshold values and the grayscale gain is determined using the section corresponding to the excess grayscale proportion, the method of deriving the grayscale gain corresponding to the excess grayscale proportion is not limited thereto.

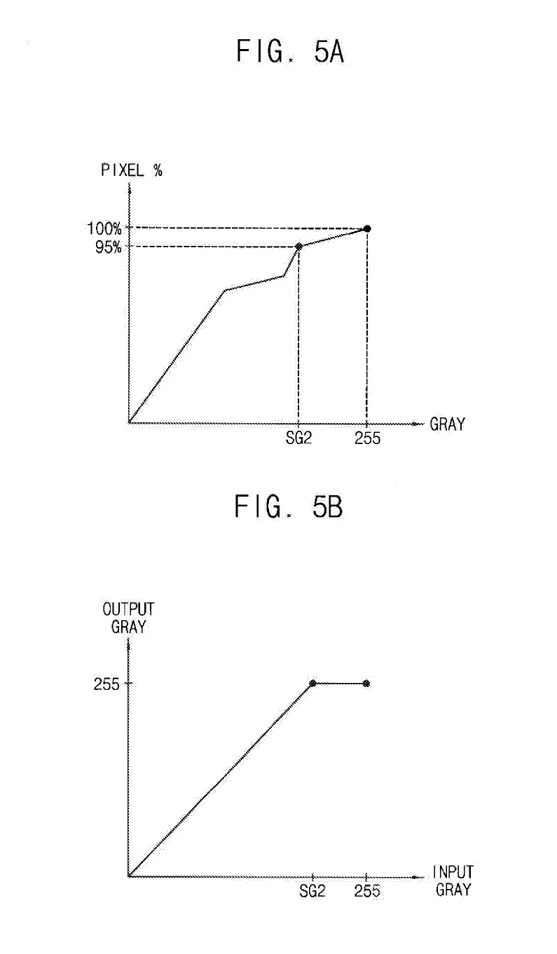

FIGS. 5A and 5B are graphs for describing still another example of determining a grayscale gain based on a grayscale distribution of input image data.

Referring to FIGS. 5A and 5B, a reference grayscale level is determined such that an excess grayscale proportion of grayscale values exceeding the reference grayscale level is greater than a predetermined threshold value. The grayscale gain can be determined such that the reference grayscale level is converted into a maximum output grayscale level.

As shown in FIG. 5A, the cumulative number of grayscale values is counted as the grayscale level increases. The reference grayscale level can be determined such that the excess grayscale proportion is greater than the threshold value. Thus, the reference grayscale level can be set to a grayscale level at which the cumulative number of grayscale values is greater than the threshold value. For example, when the threshold value is about 95%, a second reference grayscale level SG2 can be set to a grayscale level at which the cumulative number of grayscale values is greater than about 95%.

As shown in FIG. 5B, the grayscale gain is determined such that the second reference grayscale level SG2 is converted into the maximum output grayscale level. For example, the grayscale gain is determined such that the input image data corresponding to the second reference grayscale level SG2 is converted to the output image data corresponding to the maximum output grayscale level (e.g., 255).

Therefore, the reference grayscale level can be adjusted based on the grayscale distribution of the input image data, thereby decreasing the effect of deviation of input image data and efficiently reducing the power consumption.

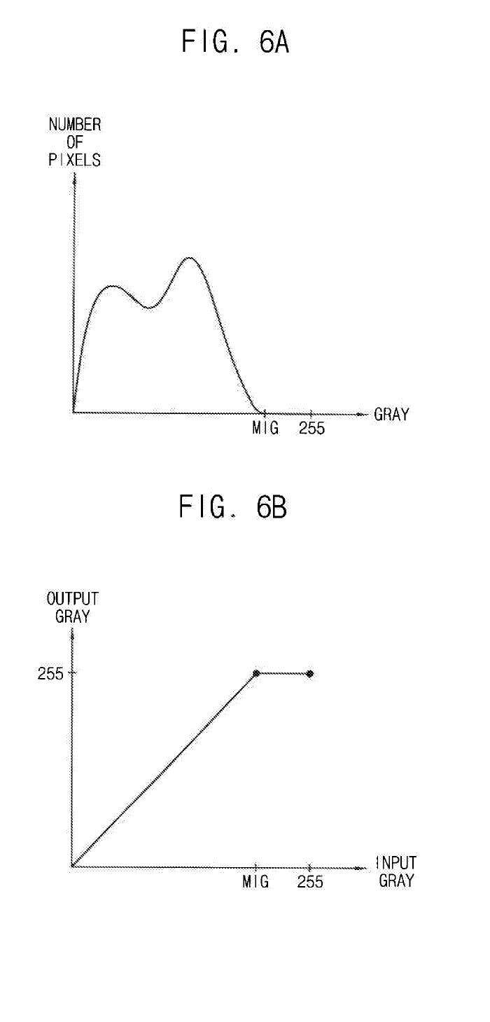

FIGS. 6A and 6B are graphs for describing still another example of determining a grayscale gain based on a grayscale distribution of input image data.

Referring to FIGS. 6A and 6B, a maximum input grayscale value is derived from the grayscale distribution, and the grayscale gain is determined based on the maximum input grayscale value.

As shown in FIG. 6A, the number of grayscale values for each grayscale level is counted from the input image data. The grayscale distribution indicating a relationship between the grayscale level and the number of the pixels can be derived. The maximum input grayscale value MIG can be derived among grayscale values in the input image data using the grayscale distribution.

As shown in FIG. 6B, the grayscale gain corresponding to the maximum input grayscale value MIG is determined. For example, the grayscale gain is determined such that the input image data having the maximum input grayscale value MIG is converted into the maximum output grayscale level (e.g., 255).

Therefore, the grayscale gain corresponding to the maximum input grayscale value MIG can be determined, thereby reducing the power consumption without a distortion or degradation of the input image data.

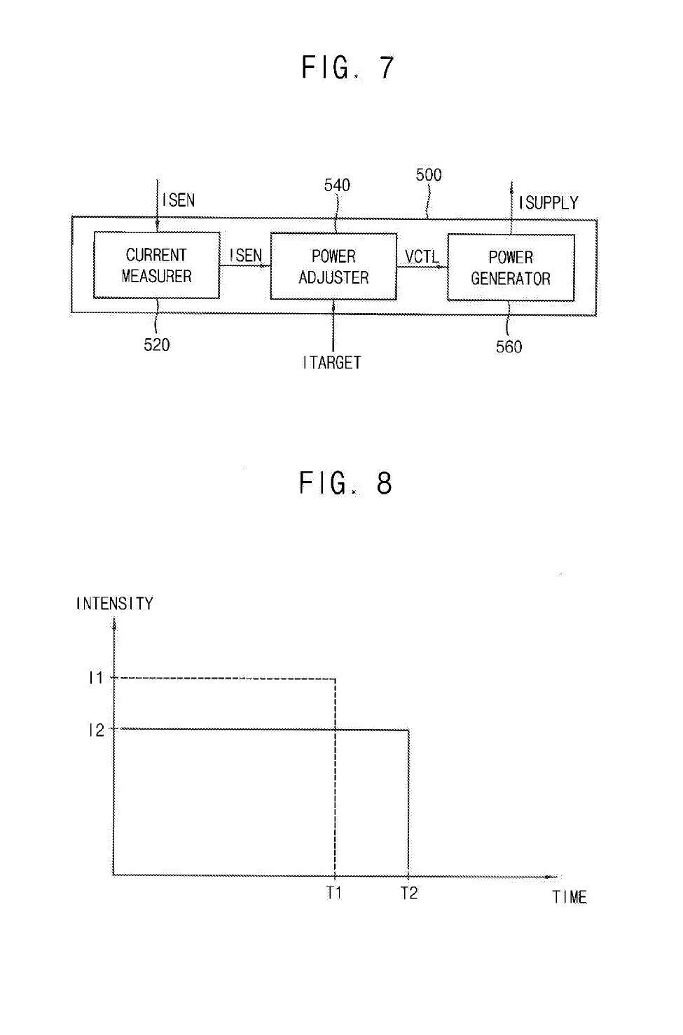

FIG. 7 is a block diagram illustrating an example of a power supply included in the OLED display of FIG. 1.

Referring to FIG. 7, the power supply 500 includes a current measurer 520, a power adjuster 540, and a power generator 560.

The current measurer 520 can measure a magnitude of a sensing current ISEN flowing through the power line. The current measurer 520 can sense the sensing current ISEN in a current sensing period to measure a luminance change occurred by a change of the grayscale gain in the display device driven by the digital driving technique.

The power adjuster 540 can compare the magnitude of the sensing current ISEN to the magnitude of the target current ITARGET. The power adjuster 540 can adjust the voltage level the power source such that the magnitude of the sensing current ISEN reaches to the magnitude of the target current ITARGET. The power adjuster 540 can adjust the voltage level the power source such that the magnitude of the sensing current ISEN reaches to the magnitude of the target current ITARGET to prevent a luminance change occurred by a change of the grayscale gain. The power adjuster 540 can provide a voltage control signal VCTL for controlling the voltage level of the power source to the power generator 560. In one example embodiment, the power adjuster 540 can adjust the voltage level of the first power source such that the magnitude of the sensing current ISEN reaches to the magnitude of the target current ITARGET. In the OLED display driven by the digital driving technique, the emission time can be increased as the grayscale gain increases. Therefore, the power adjuster 540 can decrease the voltage level of the first power source as the grayscale gain increases. Accordingly, the power adjuster 540 can decrease an intensity of the light per unit of time to maintain the total amount of current and prevent the luminance change.

The power generator 560 can generate the power source. In some embodiments, the power generator 560 generates a first power source and a second power source as the power source. A voltage level the first power source can be greater than a voltage level the second power source. For example, the first power voltage corresponds to the high power voltage and the second power source corresponds to the low power voltage. The power generator 560 can provide the generated first and second power source to the pixels included in the display panel. Each of pixels can emit light by the driving current corresponding to the voltage level of the first power source, the voltage level of the second power source, and the data signal. The power generator 560 can receive the power control signal VCTL from the power adjuster 540 to adjust the voltage level of the power source. A magnitude of a current ISUPPLY provided to the display panel can be changed by adjusting the voltage level of the power source.

FIG. 8 is a graph for describing an example of adjusting a voltage level of a power source to provide the power source corresponding to a target current.

Referring to FIG. 8, the power source corresponding to the target current is provided to the display panel by adjusting the voltage level of the power source according to a change of the grayscale gain. Despite changing of the grayscale gain, the total amount of current flowing through the display panel is not changed, thereby stably maintaining the luminance of the display panel.

The grayscale gain can be determined based on the grayscale distribution of the input image data, and the input image data can be converted into the output image data using the grayscale gain. Since the grayscale gain is greater than or equal to about 1, the grayscale level of the output image data is generally greater than or equal to the grayscale level of the input image data. Therefore, in the OLED display driven by the digital driving technique, a second emission time T2 corresponding to the grayscale level of the output image data can be greater than a first emission time T1 corresponding to the grayscale level of the input image data. The voltage level of the power source can be adjusted to maintain the total amount of current flowing through the display panel despite of changing of the grayscale level by the grayscale gain. For example, the intensity of the light per unit of time is changed from a first intensity I1 to a second intensity I2 which is less than the first intensity I1 by decreasing the voltage level of the first power source.

Therefore, the OLED display can determine the grayscale gain based on the grayscale distribution of the input image data, and convert the input image data into the output image data using the grayscale gain. In addition, the OLED display can determine the target current based on the input image data, and adjust the voltage level of the power source to provide the power source corresponding to the target current. Because the OLED display maintains the total amount of the current, the OLED display can reduce the power consumption without the luminance degradation or changing by decreasing the voltage level of the power source.

FIGS. 9 and 10 are diagrams illustrating examples where a display panel driver drives a display panel in the OLED display of FIG. 1.

Referring to FIGS. 9 and 10, the display panel driver drives the display panel by the digital driving technique. The digital driving technique displays one frame by displaying a plurality of sub-frames. In FIGS. 9 and 10, it is illustrated that one frame is divided into five sub-frames SF1 through SF5. Here, a fifth sub-frame SF5 corresponds to a blank sub-frame. Meanwhile, the number of sub-frames constituting one frame can be determined according to required conditions. Further, the blank sub-frame can be omitted.

Each sub-frame SF1, SF2, SF3, SF4, and SF5 constituting one frame has a scan time SCAN during which a scan signal is provided to pixels, an emission time EM during which the pixels emit light based on a data signal, and a reset time (not illustrated) during which the pixels are reset (i.e., states of the pixels are changed from an emission state to a non-emission state). In detail, except for the fifth sub-frame SF5 (i.e., the blank sub-frame), each emission time EM of the first through fourth sub-frames SF1, SF2, SF3, and SF4 differs by a factor of 2. That is, each emission time EM of the first through fourth sub-frames SF1, SF2, SF3, and SF4 is differently set. Thus, each emission time EM of the first through fourth sub-frames SF1, SF2, SF3, and SF4 corresponds to each bit of the data signal. For example, an emission time EM of the second sub-frame SF2 is about twice as long as an emission time EM of the first sub-frame SF1, an emission time EM of the third sub-frame SF3 is about twice as long as an emission time EM of the second sub-frame SF2, and an emission time EM of the fourth sub-frame SF4 is about twice as long as an emission time EM of the third sub-frame SF3. Here, a sub-frame having the longest emission time EM (i.e., the fourth sub-frame SF4) corresponds to the most significant bit (MSB) of the data signal, and a sub-frame having the shortest emission time EM (i.e., the first sub-frame SF1) corresponds to the least significant bit (LSB) of the data signal. As a result, a specific grayscale level is implemented based on the sum of the emission times EM of the first through fourth sub-frames SF1, SF2, SF3, and SF4.

As shown in FIG. 9, the display panel is driven by the digital driving technique of the progressive scan manner. The digital driving technique of the progressive scan manner sequentially performs scan operations of all scan-lines for each sub-frame and substantially simultaneously (or concurrently) performs emission operations of all scan-lines for each sub-frame.

As shown in FIG. 10, the display panel is driven by the digital driving technique of the random scan manner. The digital driving technique of the random scan manner randomly performs scan operations of all scan-lines for each sub-frame by shifting each sub-frame scan timing of the scan-lines by a specific time, and thus randomly (i.e., separately) performs emission operations of all scan-lines for each sub-frame.

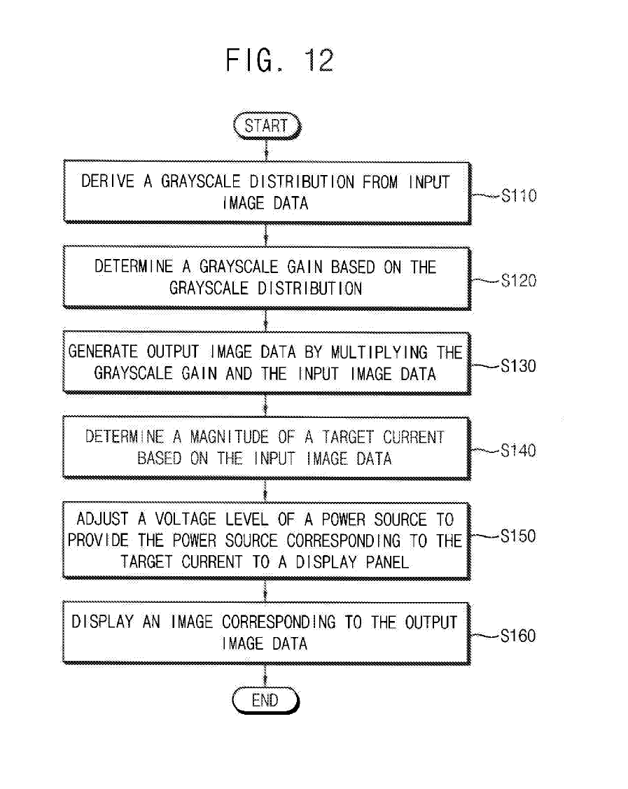

FIG. 11 is a graph for describing an effect of an OLED display of FIG. 1.

Referring to FIG. 11, the OLED display determines the grayscale gain to convert the input image data into the output image data. The OLED display can adjust the voltage level of the power source to maintain the total amount of the current. Therefore, the OLED display can reduce the power consumption without the luminance degradation or changing.

A comparison display device REF displayed an image of which proportion of low grayscale is relatively large without the conversion of the input image data. In the comparison display device REF, the power consumption by an emission unit of the pixels was measured at about 62.76 W and the power consumption by a charging unit of the pixels was measured at about 28.98 W.

On the other hand, an experimental display device EXP set the grayscale gain such that a 128 grayscale level of the input image data is converted into a 255 grayscale level of the output image data. The experimental display device EXP displayed the same image used by the comparison display device REF. In the experimental display device EXP, the power consumption by an emission unit of the pixels was measured at about 57.31 W and the power consumption by a charging unit of the pixels was measured at about 24.37 W. The experimental display device EXP can be an embodiment of the described technology.

Therefore, the experimental display device EXP reduced the power consumption by about 11% compared to the comparison display device REF. Also, the experimental display device EXP relatively largely reduced the power consumption as the proportion of low grayscale increases.

FIG. 12 is a flowchart illustrating a method of driving an OLED display according to one example embodiment.

In some embodiments, the FIG. 12 procedure is implemented in a conventional programming language, such as C or C++ or another suitable programming language. The program can be stored on a computer accessible storage medium of the OLED device 1000, for example, a memory (not shown) of the display device 1000 or the timing controller (not shown). In certain embodiments, the storage medium includes a random access memory (RAM), hard disks, floppy disks, digital video devices, compact discs, video discs, and/or other optical storage mediums, etc. The program can be stored in the processor. The processor can have a configuration based on, for example, i) an advanced RISC machine (ARM) microcontroller and ii) Intel Corporation's microprocessors (e.g., the Pentium family microprocessors). In certain embodiments, the processor is implemented with a variety of computer platforms using a single chip or multichip microprocessors, digital signal processors, embedded microprocessors, microcontrollers, etc. In another embodiment, the processor is implemented with a wide range of operating systems such as Unix, Linux, Microsoft DOS, Microsoft Windows 8/7/Vista/2000/9x/ME/XP, Macintosh OS, OS X, OS/2, Android, iOS and the like. In another embodiment, at least part of the procedure can be implemented with embedded software. Depending on the embodiment, additional states can be added, others removed, or the order of the states changed in FIG. 12.

Referring to FIG. 12, the method of driving the OLED display can determine the grayscale gain, convert input image data into output image data using the grayscale gain, and adjust the voltage level of the power source to maintain the total amount of the current, thereby reducing the power consumption without the luminance degradation and luminance changing.

For example, a grayscale distribution can be derived from input image data (S110). For example, the number of grayscale values for each grayscale level can be counted. The cumulative number of grayscale values can be counted as the grayscale level increases. The number of the grayscale values exceeding the reference grayscale level can be counted. The maximum input grayscale value among grayscale values of the input image data can be derived from the grayscale distribution.

The grayscale gain can be determined based on the grayscale distribution (S120). When a proportion of low grayscale is relatively large in the grayscale distribution of the input image data, the grayscale gain can be determined as a relatively large value. On the other hand, when a proportion of high grayscale is relatively large in the grayscale distribution of the input image data, the grayscale gain can be determined as a relatively small value.

In some embodiments, the operation of determining the grayscale gain includes an operation of calculating an excess grayscale proportion of grayscale values exceeding a reference grayscale level from the grayscale distribution and an operation of determining the grayscale gain such that the grayscale gain increases as the excess grayscale proportion decreases. For example, the excess grayscale proportion is calculated by dividing the number of pixels of which grayscale values are exceeding the reference grayscale level by the number of all pixels. The grayscale gain can be determined by comparing the excess grayscale proportion to at least one of threshold values.

In some embodiments, the operation of determining the grayscale gain includes an operation of determining a reference grayscale level such that an excess grayscale proportion of grayscale values exceeding the reference grayscale level is larger than a threshold value and an operation of determining the grayscale gain such that the reference grayscale level is converted into a maximum output grayscale level. Thus, the reference grayscale level can be determined based on the grayscale distribution such that the excess grayscale proportion is greater than or substantially equal to the threshold value. Thereafter, the grayscale gain corresponding to the reference grayscale level can be determined.

In still another example embodiment, the operation of determining the grayscale gain includes an operation of deriving a maximum input grayscale value from the grayscale distribution and an operation of determining the grayscale gain corresponding to the maximum input grayscale value.

Since methods of determining the grayscale gain are described above, duplicated descriptions will be omitted.

The output image data can be generated by multiplying the grayscale gain and the input image data (S130). For example, a relationship between the input image data and the output image data is stored in the LUT. The input image data can be converted into the output image data using the LUT corresponding to the grayscale gain.

A magnitude of a target current can be determined based on the input image data to maintain the total amount of current flowing through the display panel (S140). In some embodiment, the magnitude of the target current is calculated according to [Equation 1] below:

Itarget=εᵣGᵣ+ε_{g}G_{g}+ε_{b}G_{b}, [EQUATION 1]

where, Itarget is the magnitude of the target current, εᵣ is a weight value for a red color pixel, Gᵣ is a red color grayscale value in the input image data, ε_{g} is a weight value for a green color pixel, G_{g} is a green color grayscale value in the input image data, ε_{b} is a weight value for a blue color pixel, and G_{b} is a blue color grayscale value in the input image data.

A voltage level of a power source can be adjusted to provide the power source corresponding to the target current to a display panel (S150). A magnitude of a sensing current flowing through the power line can be measured. The voltage level of the power source can be adjusted such that the magnitude of the sensing current reaches to the magnitude of the target current. Therefore, the OLED display can maintain the total amount of current flowing through the display panel, thereby outputting the output image data without the luminance degradation.

An image corresponding to the output image data can be displayed (S160).

Although, the example embodiments describe that the display panel driver includes the timing controller, the scan driver, and the data driver, the structure of the display panel driver is not limited thereto.

The described technology can be applied to an electronic device having the OLED display. For example, the described technology can be applied to a cellular phone, a smartphone, a smart pad, a personal digital assistant (PDA), etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the inventive technology. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. An organic light-emitting diode (OLED) display, comprising:
a display panel including a plurality of pixels;
an image data converter configured to determine a grayscale gain based on a grayscale distribution of input image data and convert the input image data into output image data based on the grayscale gain;
a display panel driver configured to drive the display panel to display an image corresponding to the output image data;
a target current determiner configured to determine a magnitude of a target current based on the input image data; and
a power supply configured to provide a power source to the display panel and adjust the voltage level of the power source to correspond to the target current via a power line.

2. The display of claim 1, wherein the image data converter includes:
a grayscale distribution analyzer configured to derive the grayscale distribution from the input image data;
a grayscale gain determiner configured to determine the grayscale gain based on the grayscale distribution; and
an output image data generator configured to multiply the grayscale gain with the input image data so as to generate the output image data.

3. The display of claim 2, wherein the grayscale gain determiner is further configured to calculate an excess grayscale proportion of a plurality of grayscale values of the grayscale distribution that exceed a reference grayscale level and determine the grayscale gain corresponding to the excess grayscale proportion.

4. The display of claim 3, wherein the grayscale gain determiner is further configured to increase the grayscale gain when the excess grayscale proportion decreases.

5. The display of claim 3, wherein the grayscale gain determiner is further configured to compare the excess grayscale proportion to at least one of a plurality of threshold values and determine the grayscale gain based on the comparison.

6. The display of claim 2, wherein the grayscale gain determiner is further configured to determine a reference grayscale level such that an excess grayscale proportion of a plurality of grayscale values of the grayscale distribution that exceed the reference grayscale level is greater than a predetermined threshold value and determine the grayscale gain such that the reference grayscale level corresponds to a maximum output grayscale level.

7. The display of claim 2, wherein the grayscale gain determiner is further configured to derive a maximum input grayscale value from the grayscale distribution and determine the grayscale gain based on the maximum input grayscale value.

8. The display of claim 1, wherein the target current determiner is further configured to calculate the magnitude of the target current according to [Equation 1] below:
Itarget=εᵣGᵣ+ε_{g}G_{g}+ε_{b}G_{b}, [Equation 1]
wherein Itarget is the magnitude of the target current, εᵣ is a weight value for a red color pixel, Gᵣ is a red color grayscale value in the input image data, ε_{g} is a weight value for a green color pixel, G_{g} is a green color grayscale value in the input image data, ε_{b} is a weight value for a blue color pixel, and G_{b} is a blue color grayscale value in the input image data.

9. The display of claim 1, wherein the power supply includes:
a power generator configured to generate the power source;
a current measurer configured to measure a magnitude of a sensing current flowing through the power line; and
a power adjuster configured to compare the magnitude of the sensing current to the magnitude of the target current and adjust the voltage level of the power source such that the magnitude of the sensing current is substantially equal to the magnitude of the target current.

10. The display of claim 9, wherein the power source includes a first power source and a second power source, and
wherein a voltage level of the first power source is greater than a voltage level of the second power source.

11. The display of claim 10, wherein the power adjuster is further configured to adjust the voltage level of the first power source such that the magnitude of the sensing current is substantially equal to the magnitude of the target current.

12. The display of claim 11, wherein the power adjuster is further configured to decrease the voltage level of the first power source when the grayscale gain increases.

13. The display of claim 1, wherein the image data converter is further configured to periodically update the grayscale gain.

14. The display of claim 13, wherein the image data converter is further configured to update the grayscale gain every frame.

15. The display of claim 1, wherein the display panel driver is further configured to drive the display panel via a digital driving technique.

16. A method of driving an organic light-emitting diode (OLED) display, the method comprising:
deriving a grayscale distribution from input image data;
determining a grayscale gain based on the grayscale distribution;
multiplying the grayscale gain with the input image data so as to generate output image data;
determining a magnitude of a target current based on the input image data;
adjusting a voltage level of a power source to provide the power source corresponding to the target current to a display panel; and
displaying an image corresponding to the output image data.

17. The method of claim 16, wherein determining the grayscale gain includes:
calculating an excess grayscale proportion of a plurality of grayscale values of the grayscale distribution that exceed a reference grayscale level; and
determining the grayscale gain such that the grayscale gain increases when the excess grayscale proportion decreases.

18. The method of claim 16, wherein determining the grayscale gain includes:
determining a reference grayscale level such that an excess grayscale proportion of a plurality of grayscale values that exceed the reference grayscale level is greater than a predetermined threshold value; and
determining the grayscale gain such that the reference grayscale level corresponds to a maximum output grayscale level.

19. The method of claim 16, wherein adjusting the voltage level of the power source includes:
measuring a magnitude of a sensing current flowing through a power line;
comparing the magnitude of the sensing current to the magnitude of the target current; and
adjusting the voltage level of the power source based on the comparison such that the magnitude of the sensing current is substantially equal to the magnitude of the target current.

20. The method of claim 16, wherein the voltage level of the power source decreases when the grayscale gain increases.
